(19) United States
(12) Patent Application Publication
(10) Pub. No.: US 2006/0173588 A1
(43) Pub. Date: Aug. 3, 2006

(54) Routine checker

(76) Inventor: Colin Ross Joy, Kent Town (AU)

Correspondence Address: DALINA LAW GROUP, P.C., 7910 IVANHOE AVE. #325, LA JOLLA, CA, 92037, US

(21) Appl. No.: 10/524,246

(22) Filed: Feb. 3, 2005

(30) Foreign Application Priority Data
Jul. 10, 2002 (WO) PCT/AU03/00884

(51) Int. Cl. G06F 17/40

(52) U.S. Cl. 701/3

(57) ABSTRACT

In one form of this invention there is proposed an aid for a routine checking procedure which includes means to step through such a routine with one or more means providing an output to a checker to remind the checker of the routine step required to be performed in a preset order, characterized in that the aid further includes a means to request an emergency routine check at any time through the routine checking procedure and this being adapted to be the emergency steps of checking required at the corresponding routine step at which the checking is at the time of the emergency check.

This application is a continuation in part of International Application PCT/AU2003/000884 entitled “ROUTINE CHECKER” with an international filing date of Jul. 10, 2003, published in English under PCT Article 21(2), which is a Paris Convention filing of Australian Application 2002950094 having a priority date of Jul. 10, 2002. International application PCT/AU2003/000884 and Australian application 2002950094 are hereby incorporated by reference herein.

### BACKGROUND OF THE INVENTION

1. Field of the Invention

This invention relates to computer systems and more specifically, but not by way of limitation, relates to routine checkers and for assisting and training with regards to emergency procedures.

### DESCRIPTION OF THE RELATED ART

The use of checking references is known where for instance routine checking continues to be used by a pilot in relation to preparation and flying of an aircraft. Such an application is indicative but not comprehensive. It is currently known to have assistance when routine checking is required. There are for instance books that are used so that for instance an aeroplane pilot can use a step-by-step procedure as set down. If an emergency occurs there is also provided a checking procedure that can be read that applies for any stage of the routine. This type of routine list checking using voluminous paper based, cross-referenced folders is also used in many other fields, as for example, surgery.

What we have discovered however is that this current widely used system has difficulties.

In an emergency the implicit nature of emergency is that there may be demands on the checker which will be unpredictable and on some occasions will require the attention of the checker that makes following a written instruction difficult or perhaps impossible.

We have developed an improved procedure checking apparatus which provides an improved concept in relation to access to emergency procedures and also assists in making sure that checking procedures and their order are not lost if an emergency procedure is called for during such routine checking.

An object of this invention is to provide an answer to this described difficulty or at the least provide the public with an advantageous alternative.

### BRIEF SUMMARY OF THE INVENTION

In one form of this invention there is proposed an aid for a routine checking procedure which includes means to step through such a routine with one or more means providing an output to a checker to remind the checker of the routine step required to be performed in a preset order, characterized in that the aid further includes a means to request an emergency routine check at any time through the routine checking procedure and this being adapted to be the emergency steps of checking required at the corresponding routine step at which the checking is at the time of the emergency check.

In a further form the invention can be said to reside in an apparatus for providing an emergency procedure assisting requirement during an assisted routine checking procedure comprising a computer with a computer program providing means to effect, step by step, a visual display interpretable in each case by a user as a checking requirement in an order of the steps provided within a memory by the program of the computer, a manually operable initiation routine request member electrically connected to the computer to effect, for each manual activation, through the computer program, a signal effecting a change of a visual display showing a next checking requirement, emergency request means comprising a manually operable emergency request initiation member positioned in a close physical location to the said manually operable initiation routine request member, electrically connected to the computer to effect a visual display of an emergency checking requirement which is provided from the memory of the computer and is selected through the computer program to display a checking requirement which is matched within the computer program to be an appropriate requirement at the step for routine checking that is a current selection.

In a further form the invention can be said to reside in an apparatus for providing an emergency procedure assisting requirement during assisted routine checking procedures for and during operation of an aircraft within an aircraft and comprising a self contained body and within the body a self contained supply of electrical power further comprising within the body a computer with a computer program providing means to effect, step by step, a visual display visible from outside of the body and interpretable in each case by a user as a checking requirement in an order of the steps provided within a memory of the computer and as initiated by the user, a manually operable initiation routine request member electrically connected to the computer to effect, for each manual activation, through the computer program a signal effecting a change of a visual display showing a next checking requirement, emergency request means comprising a manually operable emergency request initiation member positioned in a close physical location to the said manually operable initiation routine request member, electrically connected to the computer to effect a visual display of an emergency checking requirement which is provided from the memory of the computer and is selected through the computer program to display a checking requirement which is matched within the computer program to be an appropriate requirement at the step for routine checking that is a current selection.

In preference such means to request an emergency routine check are a manually accessible member that is in an adjacent vicinity to a step through activator member.

In preference then there will be two buttons one alongside the other so that routine checking can be achieved by activating one button on a step by step basis and if an emergency occurs then it is simply a matter of the routine checker user changing over to the emergency activator. It is implicit that the routine check is at a stage that corresponds to the status of whatever is being checked.

Accordingly it is then a simple transition that allows for the transfer from routine checking to emergency checking which because there is a close physical location association even in most extreme situations it can be expected that the further or emergency request initiation member can be activated by a user. Such circumstances may involve loss of light, loss of power or may involve high acceleration forces or lack of oxygen.

The output can in preference as an audible interpretable message is a verbal message activated upon each step through a request. In this case then the transfer from routine to emergency at a correct stage because it is correlated in the computer program to this effect is achieved very simply by shifting from pressing one button to pressing an alternate alongside the first. With a verbal instruction available this then allows for a maximum of attention to be available to the checker for attending to the emergency.

Also, it implicitly allows for a single person to operate the stepping through procedures and the emergency checking without needing a second person.

In a further form the invention can be said to reside in a method of effecting emergency assistance during a routine checking procedure comprising in relation to an apparatus comprising a computer with a computer program providing means to effect, step by step, a visual display interpretable in each case by a user as a checking requirement in an order of the steps provided within a memory by the program of the computer, a manually operable initiation routine request member electrically connected to the computer to effect, for each manual activation, through the computer program, a signal effecting a change of a visual display showing a next checking requirement, emergency request means comprising a manually operable emergency request initiation member positioned in a close physical location to the said manually operable initiation routine request member, electrically connected to the computer to effect a visual display of an emergency checking requirement which is provided from the memory of the computer and is selected through the computer program to display a checking requirement which is matched within the computer program to be an appropriate requirement at the step for routine checking that is a current selection, the steps of initiating the manually operable initiation routine request member from time to time as each routine check in accord with the checking requirement being displayed, is complied with, and in the event of an emergency arising, initiating the manually operable initiation emergency request member located in the close physical location to the first said initiation member, which is then programmed to act in accord with a current step position of routine checking and then responding appropriately to the emergency checking requirements.

### BRIEF DESCRIPTION OF THE DRAWINGS

For a better understanding of this invention it will now be described in relation to embodiments which shall now be described with the assistance of drawings wherein:

FIG. 1 is an illustration of an embodiment with a control handle with an associated keypad; and a multi-line text display with an associated spoken word output.

FIG. 2 shows the keypad and display apparatus.

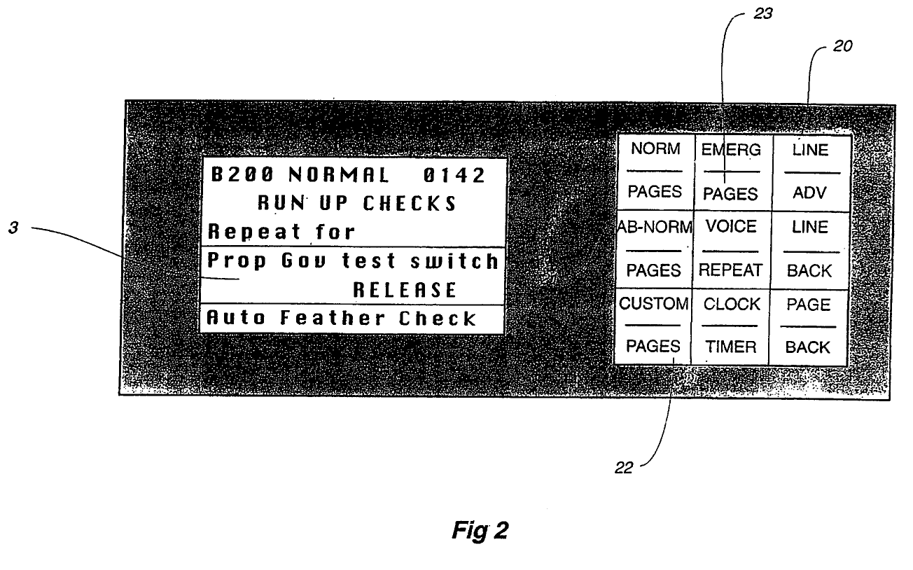

FIG. 3 is a schematic representation of the method of using the device.

### DETAILED DESCRIPTION OF THE INVENTION

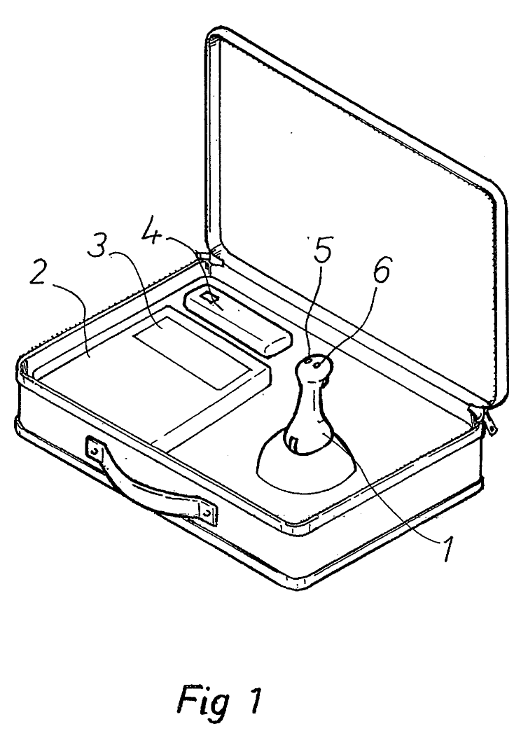

The embodiment of FIG. 1 is intended for aeronautical use, so control is provided by a joystick 1 arrangement. There is a computer with a program that is such that the functions described will as occur. There are currently a number of computers which term includes the operating units for a computer which includes a central processing unit, a memory, an indexing facility and an input and output unit.

Control input is also provided by a 9-button keypad 2. Output is available from a voice synthesizer arrangement (not shown) which ensures that there is therefore available an audible signal matching the message of a visual display at any time, and a multi-line text visual display 3. There is also a backup battery 4 allowing the system to operate for extended periods independently of an external power source so that there is within a self contained body with a self contained supply of electrical power. This is not intended to be used unless there is a loss of external power so there is an automated transfer of power supply arranged in the event of an external loss of power to an internal battery supply.

For every type of aircraft, there exist checklists which seek to cover every imaginable permutation of normal and abnormal behaviour which might be encountered by an aircraft in service. These can be divided into four general classes. The NORMAL list contains the checks to be done in normal operation. The ABNORMAL list is a fault finding/clearing list which is entered when an item in the NORMAL list is found to be in an abnormal condition. The EMERGENCY list contains the items to be checked through in a variety of possible emergency situations. There may also be a CUSTOM list which contains such things as abbreviated versions of the normal checklists or checklists annotated with details specific to that individual aircraft or operating area.

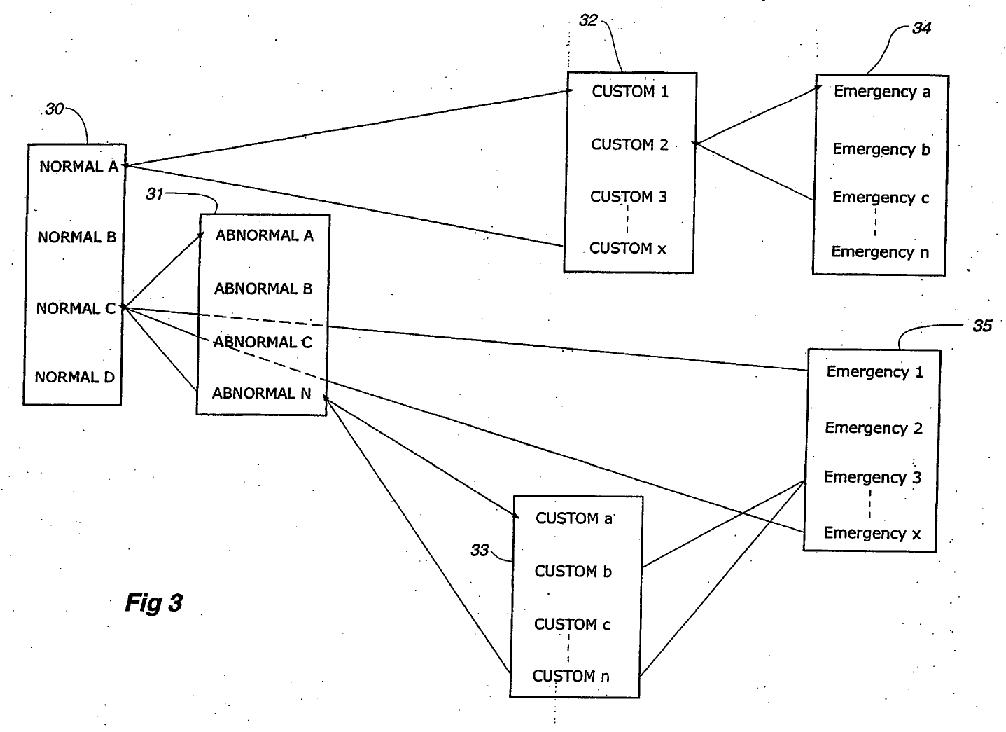

FIG. 3 shows the logical progression of use of the system. The pilot or other member of the flight deck crew begins the checklist at the first NORMAL item 30. The detail of the item is displayed on the screen 3 and read out by the voice synthesizer. As each item is checked with a normal result, the pilot advances to the next item by pressing the button 5 on the joystick. This advance can also be achieved by pressing the LINE-ADV key 20 on the keypad.

If the item does not check normal, the fault finding/clearing checklist appropriate to that item 31 is entered by pressing the AB-NORM-PAGES button 21 on the keypad. This list is then run through item by item by use of the line advance function, that is by pressing the joystick button 5 or the keypad key 20 At the end of this checklist, the fault condition has been dealt with, and the system returns to the item in the NORMAL list from which the branch to the ABNORMAL list occurred.

At any point in the process, the CUSTOM list 32, 33 associated with an item in the NORMAL or ABNORMAL lists may be entered by pressing the CUSTOM-PAGES button 22. This list is then progressed through using the line advance function. On completion of the list, the system returns to the checklist item from which the branch to the CUSTOM list occurred.

The apparatus is constantly active during the operation, with pre-flight lists, take-off lists, general flight lists and landing lists being worked through. Thus the system keeps track of the last completed checklist point, even when it is not actively moving through a list. At any time, an unexpected emergency may occur. The emergency button 6 on the joystick which is then a manually operable emergency request initiation member which is also in a close physical location to the button acting as the normal manually operable routine request member is then pressed to gain access to the emergency checklist 34, 35 appropriate to the stage of flight the aircraft is in, based on the position the system is in the checklist data structure. The closeness of the respective initiation members is intended to facilitate the ability of a user to have a simplest of steps and a minimum distance of travel for a finger or thumb to enable the transfer to be done with least effort and time and given that this is intended to be used even in extreme emergencies the closeness in a physical sense can be chosen for each situation being as close as reasonable in the physical arrangement of the buttons. This list may incidentally also be accessed by pressing the EMERG-PAGES button 23 on the keypad. The emergency checklist is worked through using the line advance function, allowing the pilot to continue concentrating on flying the aircraft.

The items of the routine check are provided to the apparatus in the form of text, and are displayed in this form. The verbal output is provided by a text to speech processor.

As is now seen, the concept of providing a very easily accessible selection to an emergency checklist provides significant advantages.

In a further embodiment, the system is used by a surgeon. In complex surgical procedures, a member of the theatre staff is occupied reading out to the surgical team the checklist for the procedure. The anesthetist will require a different checklist to the surgeon. The logical structure of the checklists, moving between NORMAL, ABNORMAL, CUSTOM and EMERGENCY lists will be similar to the previous embodiment, with the detail of the items being replaced with the appropriate checklist items for the surgical procedure being performed. In this embodiment, the joystick control is replaced by a foot operated control arrangement, having the same line advance and emergency selection functions.

What is claimed is:

1. An apparatus for providing an emergency procedure assisting requirement during an assisted routine checking procedure comprising:
a computer having a computer program configured to effect a visual display interpretable in each case by a user as a checking requirement in an order of the steps provided within a memory of said computer by said program associated with said computer;
a manually operable initiation routine request member electrically connected to said computer to effect, for each manual activation, through said computer program, a signal effecting a change of a visual display showing a next checking requirement; and,
an emergency request element comprising a manually operable emergency request initiation member positioned in a close physical location to said manually operable initiation routine request member, electrically connected to said computer to effect a visual display showing an emergency checking requirement which is provided from said memory of said computer and is selected through said computer program to display a subsequent checking requirement which is matched within said computer program to be an appropriate requirement at a step for routine checking that is a current selection.

2. The apparatus of claim 1 further comprising:
said computer program further comprising instructions to initiate or effect directly in correlation with and as each visual display is being displayed, a user interpretable audible signal uniquely identifying one or more of said checking requirement.

3. The apparatus of claim 2 further wherein said audible signal is generated by replication of text corresponding to said checking requirement into spoken word.

4. An apparatus for providing an emergency procedure assisting requirement during an assisted routine checking procedure comprising:
said apparatus configured for use during operation of an aircraft within said aircraft and comprising a self contained body;
said body comprising a self contained supply of electrical power further comprising within said body a computer comprising a computer program element configured to effect a visual display visible from outside of said body and interpretable in each case by a user as a checking requirement in an order of the steps provided within a memory of said computer and as initiated by said user;
a manually operable initiation routine request member electrically connected to said computer configured to effect, for each manual activation, through said computer program a signal effecting a change of a visual display showing a next checking requirement;
an emergency request element comprising a manually operable emergency request initiation member positioned in a close physical location to said manually operable initiation routine request member electrically connected to said computer to effect a visual display of an emergency checking requirement which is provided from said memory of said computer and is selected through said computer program to display a subsequent checking requirement which is matched within said computer program to be an appropriate requirement at a step for routine checking that is a current selection.

5. The apparatus of claim 4 further comprising:
said computer program further comprising instructions to initiate or effect directly in correlation with and as each visual display is being displayed, a user interpretable audible signal uniquely identifying one or more of said checking requirement.

6. The apparatus of claim 5 further wherein said audible signal is generated by replication of text corresponding to said checking requirement into spoken word.

7. A method of effecting emergency assistance during a routine checking procedure comprising:
initializing a computer program running on a computer;
providing a visual display interpretable in each case by a user as a checking requirement in an order of the steps provided within a memory via said computer program on said computer;
operating a manually operable initiation routine request member electrically connected to said computer;
effecting a change of a visual display for each manual activation of said request member;
showing a next checking requirement;
operating a manually operable emergency request initiation member in a close physical location to said manually operable initiation routine request member, wherein said manually operable emergency request initiation member is electrically connected to said computer to effect a visual display of an emergency checking requirement which is provided from said memory of said computer;
selecting through said computer program a checking requirement to display which is matched within the computer program to be an appropriate requirement at the step for routine checking that is a current selection;
initiating said manually operable initiation routine request member from time to time as per each routine check in accord with said checking requirement being displayed, is to ensure said checking requirement is complied with in the event of an emergency;
initiating the manually operable initiation emergency request member located in the close physical location to the first said initiation member, which then acts in accord with a current step position of routine checking; and,
responding appropriately to said emergency checking requirements.
